(19) United States
(12) Patent Application Publication
(10) Pub. No.: US 2010/0280650 A1
(43) Pub. Date: Nov. 4, 2010

(54) MACHINING APPARATUS AND MACHINING METHOD

(75) Inventors: Fuminori Takami, Osaka (JP); Masahiro Kubo, Osaka (JP)

Correspondence Address: HAMRE, SCHUMANN, MUELLER & LARSON P.C., P.O. BOX 2902, MINNEAPOLIS, MN, 55402-0902, US

(73) Assignee: Panasonic Corporation, Osaka (JP)

(21) Appl. No.: 12/771,426

(22) Filed: Apr. 30, 2010

(30) Foreign Application Priority Data
Apr. 30, 2009 (JP) 2009-110227

(51) Int. Cl. G05B 19/19

(52) U.S. Cl. 700/186

(57) ABSTRACT

A machining apparatus capable of easing positioning restrictions on machined shapes and improving the shape accuracy and positional accuracy of the machined shapes. A machining tool forms a machined shape in a workpiece mounted on a workpiece mounting surface, by means of a rotational shaft causing the machining tool to rotate, and three linear axes moving the machining tool so as to follow the machined shape of a machining object while moving the center of the intended formation region of the machined shape of the machining object in a circular arc shape in accordance with the rotation of the machining tool.

The disclosure of Japanese Patent Application No. 2009-110227 filed Apr. 30, 2009 including specification, drawings and claims is incorporated herein by reference in its entirety.

### BACKGROUND OF THE INVENTION

1. Field of the Invention

The present invention relates to a machining apparatus and a machining method for forming a machined shape such as an axially symmetrical shape, an axially asymmetrical shape, or a free form surface shape in a workpiece for machining.

2. Description of the Related Art

In recent years, with progress in the miniaturization, improved performance, and increased capacity of optical equipment, advances have been made in reducing the curvature and diameter of optical elements used in optical equipment, as well as improving accuracy and achieving complex shapes. Against this background, optical elements are present in which spherical or aspherical concave surfaces or convex surfaces are arranged in an array configuration. In an optical element in which machined shapes such as concave surfaces are arranged in an array configuration, the shape accuracy of each machined shape as well as the positional accuracy of the shape has a great effect on the performance of the optical element.

Japanese Patent Application Laid-open No. 2000-246614, for example, discloses an optical element in which machined shapes are arranged in an array configuration, a mold for forming such an optical element, or a conventional machining apparatus for forming a master mold for forming such a mold. FIG. 5 shows the conventional machining apparatus disclosed by Japanese Patent Application Laid-open No. 2000-246614.

The conventional machining apparatus shown in FIG. 5 forms a rotational curved surface in which the center of rotation is a position O′ offset from a center O of a workpiece 1. This machining apparatus includes a rotational drive shaft (C axis) 2 for rotating the workpiece 1 about the center O, three linear drive axes (X axis, Y axis and Z axis) for linearly moving a front end portion 3a of a machining tool 3 with respect to the workpiece 1 in three axial directions orthogonal to each other, and an NC control device 4 for performing numerical control on the three linear drive axes and the one rotational drive shaft 2. In this machining apparatus, the relative positions of the offset position O′ and the front end portion 3a of the machining tool 3 are numerically controlled by the NC control device 4, while the front end portion 3a of the machining tool 3 is turned so as to follow the offset position O′ rotating about the rotation center of the rotational drive shaft 2 (the rotation center of the workpiece 1) O. By means of this operation, a rotational curved surface having a rotation center at the offset position O′ is formed.

However, the conventional machining apparatus described above has problems that: (1) the arrangement of the rotational curved surface is limited; (2) variations occur in the shape accuracy of the rotational curved surface; and (3) variations also occur in the positional accuracy of the rotational curved surface. These problems are described below.

(1) The arrangement of the rotational curved surface is limited by the restrictions of the machining device and accuracy. Firstly, the limitations on the arrangement of the rotational curved surface by the restrictions of the machining device will be described. In the conventional machining apparatus described above, when a rotational curved surface is formed at the offset position O′ distant from the rotation center O, then the front end portion 3a of the machining tool 3 is turned so as to follow the offset position O′ rotating about the rotation center O. Accordingly, the linear drive axes require an operation range of at least the diameter of the turning trajectory of the offset position O′, in other words, an operation range of at least twice the distance from the rotation center O to the offset position O′. Consequently, in the conventional machining apparatus, the rotational curved surface can be arranged within a range of up to a half of the operation range of the linear drive axis from the rotation center O.

Next, the limitations on the arrangement of the rotational curved surface by the restrictions of accuracy will be described. In the conventional machining apparatus described above, when a rotational curved surface is formed at the offset position O′ distant from the rotation center O, then the front end portion 3a of the machining tool 3 is turned so as to follow the offset position O′ rotating about the rotation center O. Therefore, the moving distance of the linear drive axis increases with the distance of the offset position O′ from the rotation center O, so that the feed velocity of the linear drive axis also increases.

For example, when the rotational drive shaft 2 was rotated at a rate of 50 revolutions [min⁻¹] and rotational curved surfaces were formed which are centered about the offset positions O′ distanced respectively by 1 mm, 5 mm and 20 mm from the rotation center O, as shown in FIG. 6, then the moving velocities of the machining tool (the feed velocities of the linear drive axis) were approximately 314 [mm/min], approximately 1570 [mm/min] and approximately 6280 [mm/min], respectively. Thus, the feed velocity of the linear drive axis increases with the distance of the offset position O′ from the rotation center O. However, in current ultra-high-precision machining apparatuses, a feed velocity of over 1000 [mm/min] is not realistic from the viewpoint of accuracy improvement. Consequently, in the conventional machining apparatus, the arrangement of the rotational curved surface is restricted by the limits of the feed velocity of the linear drive axis.

The rotation speed of the rotating drive shaft may conceivably be reduced and the linear drive axis may be operated within the limits of the feed velocity of the linear drive axis as a measure, but such a method requires a huge amount of machining time. If the machining time becomes too long, then changes in temperature and humidity and vibrations caused by comings and goings of staff to and from a room where the machining apparatus is located have an effect, making it difficult to improve the accuracy of a machined shape. Furthermore, in the case of a cutting operation using a cutting tool, if the rotation speed is too slow, then there is a risk of wear of the tool and the deterioration of surface texture (surface property and state) of the workpiece involved.

(2) In the conventional machining apparatus described above, when a rotational curved surface is formed at the offset position O′ distant from the rotation center O, then the front end portion 3a of the machining tool 3 is turned so as to follow the offset position O′ rotating about the rotation center O. Consequently, the machining data and the feed velocity of the linear drive axis are different for each rotational curved surface. Furthermore, as the distance from the rotation center O to the offset position O′ increases, then an error in the resolution pitch of the rotational drive axis 2 also increases. Due to these facts, variations occur in the shape accuracy of the rotational curved surface.

(3) As described above, the moving distance of the linear drive axis increases with the distance of the offset position O′ from the rotation center O, and accordingly the feed velocity of the linear drive axis also increases. Therefore, as the offset position O′ moves away from the rotation center O, the linear drive axis is delayed in following and the positional accuracy of the rotational curved surface deteriorates. Positional errors caused by this delay in following are different for each offset position O′. For this reason, variations occur in the positional accuracy of the rotational curved surface. Moreover, as described above, the larger the distance of the offset position O′ from the rotation center O, the larger the error in the resolution pitch of the rotational drive shaft 2. Consequently, the error in this resolution pitch also causes variations in the positional accuracy of the rotational curved surface.

### SUMMARY OF THE INVENTION

The present invention has been devised in view of the conventional problems described above, an object thereof being to provide a machining apparatus and a machining method whereby restrictions on the arrangement of machined shapes can be eased, and the shape accuracy and positional accuracy of the machined shapes can be improved.

In order to achieve the object stated above, a machining apparatus according to the present invention includes: a rotational shaft; a tool mounting surface on the rotational shaft; a machining tool mounted on the tool mounting surface; a workpiece mounting surface opposing the tool mounting surface; and three linear axes for moving the tool mounting surface and the workpiece mounting surface relatively in three axial directions orthogonal to each other, and the machining tool forms a machined shape in a workpiece mounted on the workpiece mounting surface, by means of the rotational shaft causing the machining tool to rotate, and the three linear axes moving the machining tool so as to follow the machined shape of a machining object while moving the center of an intended formation region of the machined shape of the machining object in a circular arc shape in accordance with the rotation of the machining tool.

In the machining apparatus according to the present invention described above, the rotational shaft and the three linear axes may be operated such that a plurality of machined shapes are formed in the workpiece mounted on the workpiece mounting surface.

The machining apparatus according to the present invention described above may further include a two-axis table, disposed on the tool mounting surface, for holding the machining tool. This two-axis table may position the front end of the machining tool on the axis line of the rotational shaft.

In the machining apparatus according to the present invention described above, the three linear axes may correct a positional deviation between the front end of the machining tool and the axis line of the rotational shaft during the formation of the machined shape. In this case, the two-axis table described above may position the front end of the machining tool in the vicinity of the axis line of the rotational shaft.

In the machining apparatus according to the present invention described above, the machining tool may be a cutting tool or a grinding tool.

In the machining apparatus according to the present invention described above, if the machining tool is a cutting tool, then the rotational shaft and the three linear axes may maintain a constant angle of the rake surface of the machining tool with respect to the advance direction of the intended formation region of the machined shape of the machining object, during the formation of the machined shape of the machining object.

In the machining apparatus according to the present invention described above, if the machining tool is a cutting tool, then the rotational shaft and the three linear axes may alter the angle of the rake surface of the machining tool with respect to the advance direction of the intended formation region of the machined shape of the machining object, and may change a portion of the machining tool to be in contact with the workpiece mounted on the workpiece mounting surface, during the formation of the machined shape of the machining object.

Furthermore, in order to achieve the object stated above, a machining method according to the present invention is a machining method for forming a machined shape in a workpiece mounted on a workpiece mounting surface, by controlling the operation of a rotational shaft for rotating a tool mounting surface on which a machining tool is mounted and the operation of three linear axes for relatively moving the tool mounting surface and the workpiece mounting surface opposing the tool mounting surface in three axial directions orthogonal to each other, wherein, after the machining tool is aligned in a machining start position on the intended formation region of the machined shape of a machining object, the machining tool is moved following the machined shape of the machining object, while the center of the intended formation region of the machined shape is moved in a circular arc shape in accordance with the rotation of the machining tool.

In the machining method according to the present invention described above, a plurality of machined shapes may be formed in the workpiece mounted on the workpiece mounting surface, by repeating the step of aligning the machining tool in the machining start position on the intended formation region of the machined shape of the machining object, and then moving the machining tool to follow the machined shape of the machining object, while moving the center of the intended formation region of the machined shape of the machining object in a circular arc shape in accordance with the rotation of the machining tool.

In the machining method according the present invention described above, before forming the machined shape, the front end of the machining tool may be positioned on the axis line of the rotational shaft by controlling the operation of a two-axis table that is disposed on the tool mounting surface and that holds the machining tool.

In the machining method according to the present invention described above, the machined shape may be formed in the workpiece mounted on the workpiece mounting surface while correcting a positional deviation between the front end of the machining tool and the axis line of the rotational shaft. In this case, before forming the machined shape, the front end of the machining tool may be positioned in the vicinity of the axis line of the rotational shaft by controlling the operation of a two-axis table that is disposed on the tool mounting surface and that holds the machining tool.

In the machining method according to the present invention described above, a cutting tool or a grinding tool may be used as the machining tool.

In the machining method according to the present invention described above, a cutting tool may be used as the machining tool, and the angle of the rake surface of the machining tool may be maintained constant with respect to the advance direction of the intended formation region of the machined shape of the machining object, during the formation of the machined shape of the machining object.

In the machining method according to the present invention described above, a cutting tool may be used as the machining tool, and the angle of the rake surface of the machining tool with respect to the advance direction of the intended formation region of the machined shape of the machining object may be altered and a portion of the machining tool to be in contact with the workpiece mounted on the workpiece mounting surface may be altered, during the formation of the machined shape of the machining object.

According to a desirable mode of the present invention, positional restrictions on the machined shapes are eased and the shape accuracy and positional accuracy of the machined shapes are improved. Therefore, according to the desirable mode of the present invention, it is possible to achieve high accuracy in an optical element in which concave surfaces or convex surfaces are arranged in an array configuration, or in a mold or master mold for forming such an optical element.

### BRIEF DESCRIPTION OF THE DRAWINGS

FIG. 1A is a schematic drawing showing a side view of the composition of a machining apparatus according to an embodiment of the present invention;

FIG. 1B is a schematic drawing showing a top view of the composition of a machining apparatus according to the embodiment of the present invention;

FIG. 2 is a perspective diagram of after machining a workpiece according to the embodiment of the present invention;

FIG. 3 is a diagram showing the aspect of a workpiece and the rake surface of a bit during machining by the machining apparatus according to the embodiment of the present invention;

FIG. 4 is an enlarged diagram showing the relationship between the workpiece and the rake surface of the bit during machining by the machining apparatus according to the embodiment of the present invention;

FIG. 5 is a perspective diagram showing the composition of a conventional machining apparatus; and

FIG. 6 is an explanatory diagram showing the relationship between the central position of a rotational curved surface and the moving velocity of a machining tool in the conventional machining apparatus, for comparison with the present invention.

### DESCRIPTION OF THE PREFERRED EMBODIMENTS

Below, an embodiment of the present invention is described referring to the drawings. In the respective drawings, the same constituent elements are labelled with the same reference numerals and duplicated description thereof is omitted.

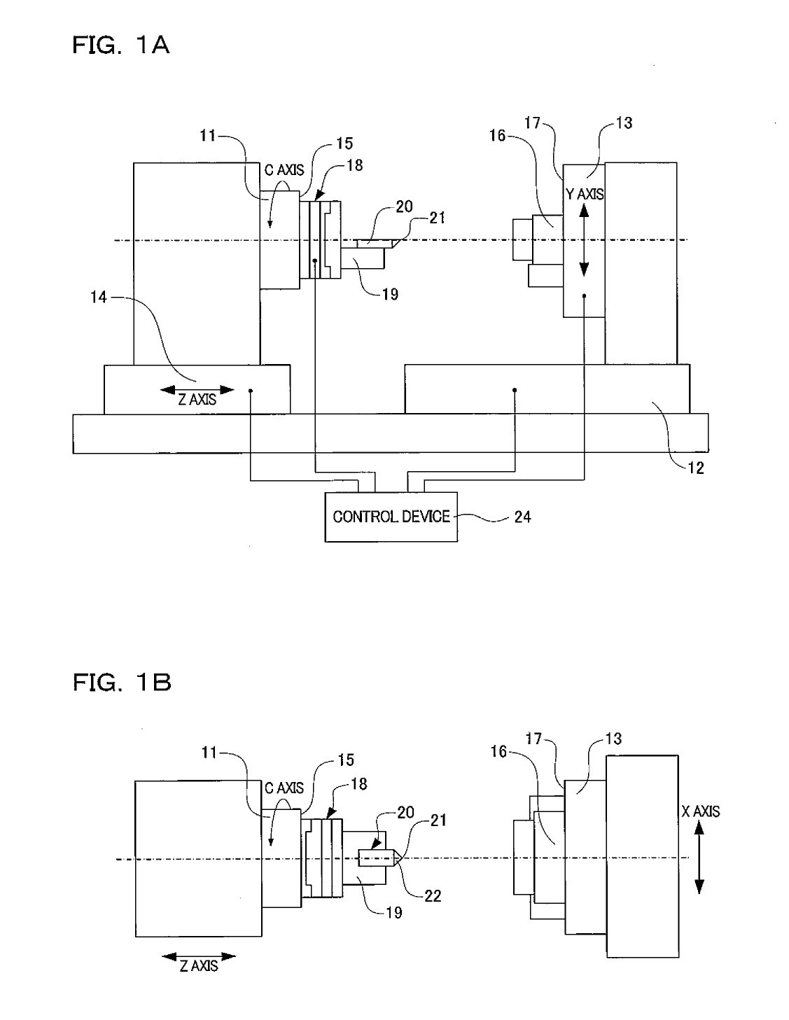

As shown in FIG. 1A and FIG. 1B, a machining apparatus includes a rotational drive shaft 11, an X axis table 12, a Y axis table 13 and a Z axis table 14. The X axis table 12, Y axis table 13 and Z axis table 14 constitute three linear drive axes which advance linearly in three axial directions orthogonal to each other.

A tool mounting surface 15 is provided on the rotational drive shaft 11 so as to be orthogonal to the rotation axis (C axis) of the shaft 11. A machining tool is mounted on the tool mounting surface 15. Meanwhile, a workpiece mounting surface 17 is provided on the Y-axis table 13. A workpiece 16 is mounted on the workpiece mounting surface 17.

The rotational drive shaft 11 is provided on the Z-axis table 14 which is a linear drive axis for moving linearly in the Z axis direction. This rotational drive shaft 11 is arranged in such a manner that the axis line of the C axis is parallel with the axis line of the Z axis. On the other hand, a Y-axis table 13 is provided on top of the X-axis table 12 which is a linear drive axis for moving linearly in the X-axis direction orthogonal to the Z-axis direction. The Y-axis table 13 is a linear drive axis for moving linearly in the Y-axis direction orthogonal to the Z-axis direction and the X-axis direction. The Y-axis table 13 is disposed in such a manner that the workpiece mounting surface 17 opposes the tool mounting surface 15 and lies orthogonal to the axis line of the C axis.

As described above, the machining apparatus is configured in such a manner that the tool mounting surface 15 and the workpiece mounting surface 17 are moved relatively with respect to each other in three axial directions orthogonal to each other (X-axis direction, Y-axis direction and Z-axis direction), by means of the X-axis table 12, the Y-axis table 13 and the Z-axis table 14 which are three linear drive axes.

Furthermore, the machining apparatus is equipped with a two-axis moving table 18 which moves linearly in two directions orthogonal to each other and is mounted on the tool mounting surface 15. A tool holder 19 for holding the machining tool is attached to the two-axle moving table 18. In this way, the machining apparatus employs a composition in which the machining tool is held by the two-axis moving table 18 mounted on the tool mounting surface 15, as a composition for mounting the machining tool on the tool mounting surface 15 on the C axis.

Furthermore, the machining apparatus also includes a control device 24. The control device 24 controls the operations of the four axles described above (X axis, Y axis, Z axis and C axis) so as to form a desired machined shape on the workpiece 16 mounted on the workpiece mounting surface 17. For example, an NC control device for controlling the four axes described above numerically can be used as the control device 24. Here, the control device 24 also has a function of controlling the operation of the two-axis moving table 18.

In the present embodiment, a case is described in which a cutting operation is carried out using a bit 20, which is a cutting tool as the machining tool. The bit 20 is disposed in such a manner that a front end 21 thereof is positioned on the axis line of the C axis. Here, the front end 21 of the bit 20 is positioned on the axis line of the C axis by the two-axis moving table 18. Furthermore, in an initial state, the bit 20 is disposed so as to face toward the opposite side from the Z-axis table 14, with a rake surface 22 thereof orthogonal to the Y-axis direction. The operation of the four axes described above is controlled by setting the angle of the C axis in this initial state to be zero degrees.

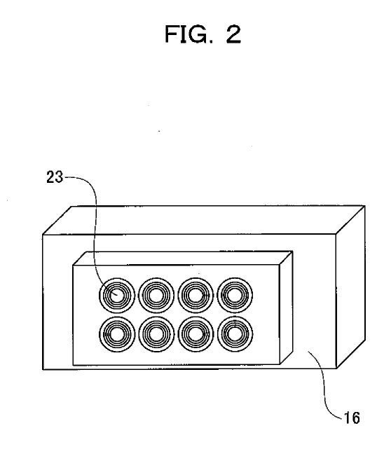

FIG. 2 is a perspective diagram of after machining the workpiece 16 in the present embodiment. Here, a case is described in which the workpiece 16 is machined to prepare a master mold for forming a lens array which is an optical element with axially symmetrical concave surface diffracting shapes arranged in an array configuration. In other words, a case is described in which a plurality of axially symmetrical concave surface diffracting shapes 23 are formed in an array configuration in the workpiece 16. This master mold requires a precision of several 10 nm or less in terms of the shape accuracy of the axially symmetrical concave surface diffracting shapes 23. Moreover, the precision of a sub-micron level is required in terms of the positional accuracy of the axially symmetrical concave surface diffracting shapes 23.

Next, the operation of the four axes described above when forming the axially symmetrical concave surface diffracting shape 23 will be explained. In the present embodiment, the machining apparatus moves the center of the intended formation region of the axially symmetrical concave surface diffracting shape 23 to be machined, in accordance with the rotation of the bit 20 by the rotational drive shaft 11, so as to travel in a circular arc shape by means of the X-axis table 12 and the Y-axis table 13, as well as moving the bit 20 by means of the Z-axis table 14 so as to follow the axially symmetrical concave surface diffracting shape 23 to be machined. In this case, the center of the intended formation region of the axially symmetrical concave surface diffracting shape 23 is moved in a circular arc shape in accordance with the rotation of the bit 20, in such a manner that the rake surface 22 of the bit 20 forms a predetermined angle with respect to the travel direction of the intended formation region of the axially symmetrical concave surface diffracting shape 23. By this operation of the four axes, the axially symmetrical concave surface diffracting shape 23 to be machined is formed.

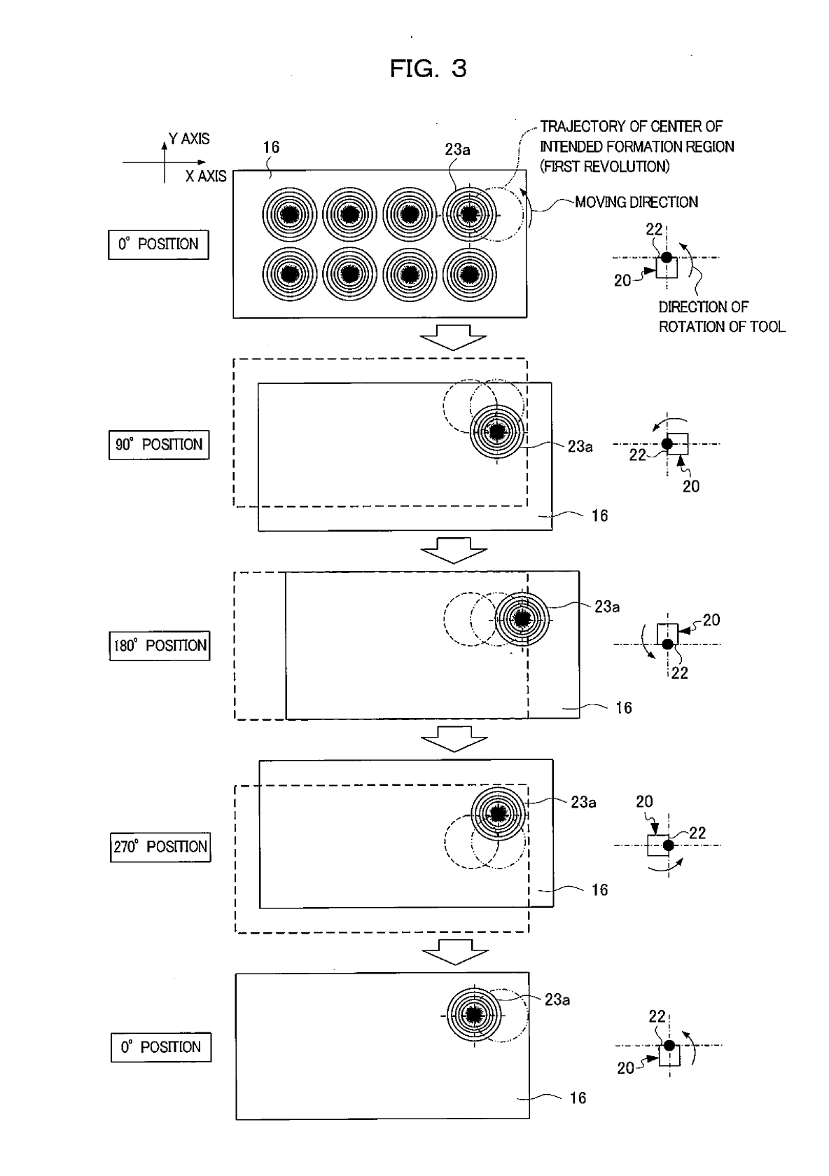

FIG. 3 is a diagram showing the aspects of the workpiece 16 and the rake surface 22 of the bit during machining by the machining apparatus according to the present embodiment. Specifically, FIG. 3 shows the aspects of the workpiece 16 and the rake surface 22 of the bit from the start of machining an intended formation region 23a of the axially symmetrical concave surface diffracting shape to be machined, from the outer side, until the C axis has performed one revolution, the aspects being depicted at 90-degree intervals. In FIG. 3, the double-dotted line indicates the trajectory of the center of the intended formation region 23a of the axially symmetrical concave surface diffracting shape to be machined. Furthermore, the broken line indicates the positions of the workpiece 16 and the intended formation region 23a of the axially symmetrical concave surface diffracting shape to be machined, at the start of machining.

Firstly, before the start of machining, the front end of the bit 20 is positioned on the axis line of the C axis by means of the machining apparatus controlling the operation of the two-axis moving table 18. The machining apparatus positions the front end of the bit 20 at the machining start position on the intended formation region 23a of the axially symmetrical concave surface diffracting shape to be machined. Thereafter, the machining apparatus moves the center of the intended formation region 23a of the axially symmetrical concave surface diffracting shape to be machined, in a circular arc-shaped trajectory as indicated by the double-dotted line. At this point, the machining apparatus moves the center of the intended formation region 23a of the axially symmetrical concave surface diffracting shape in a circular arc shape in accordance with the rotation of the bit 20, in such a manner that the orientation of the rake surface 22 of the bit maintains a constant angle at all times with respect to the advance direction of the intended formation region 23a of the axially symmetrical concave surface diffracting shape. By means of this operation, a cutting operation proceeds. FIG. 3 shows a case where the orientation of the rake surface 22 of the bit is at an angle of 180 degrees at all times with respect to the advance direction of the intended formation region 23a of the axially symmetrical concave surface diffracting shape.

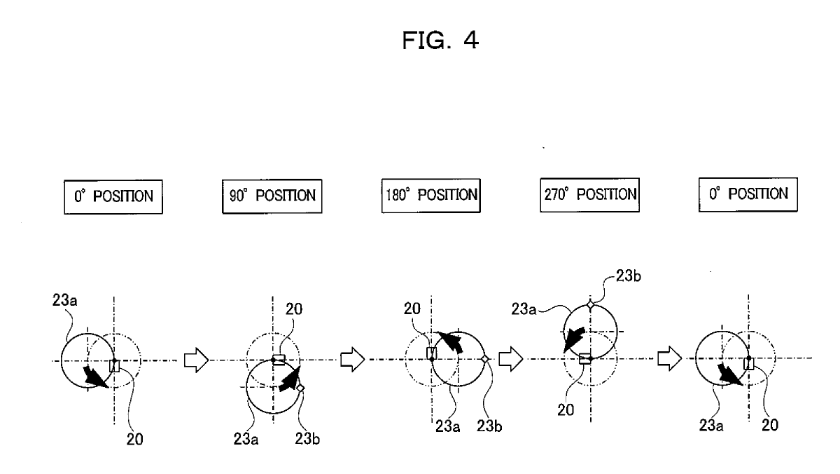

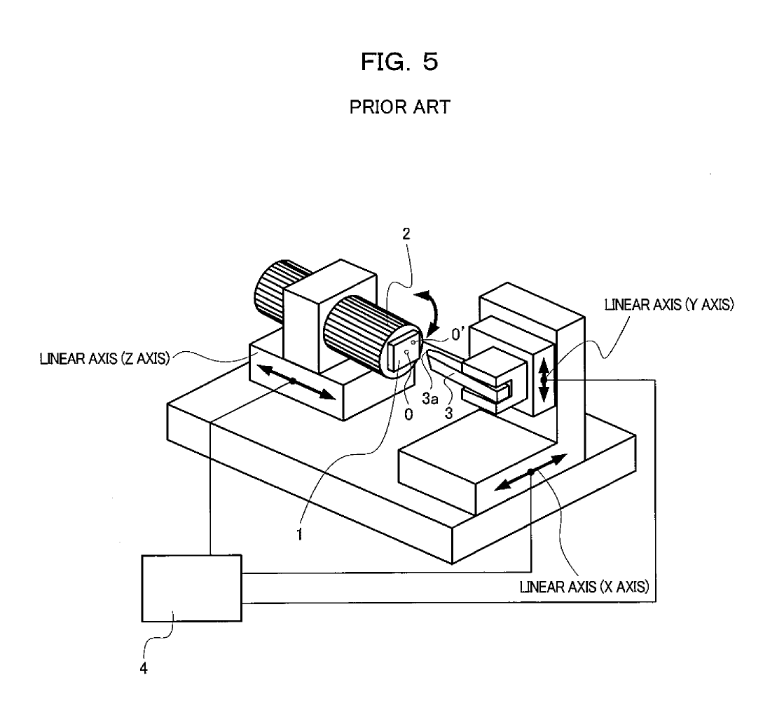

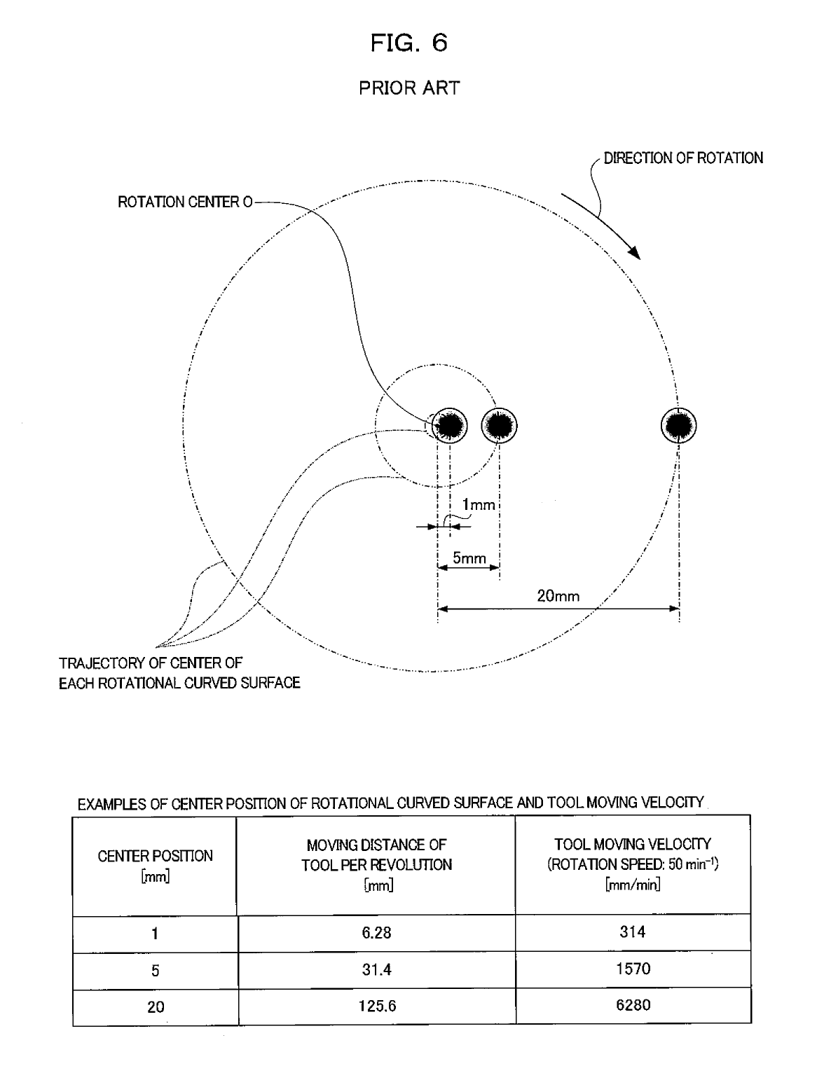

FIG. 4 is an enlarged diagram showing the relationship of the workpiece 16 and the rake surface 22 of the bit during machining by the machining apparatus according to the present embodiment. Specifically, FIG. 4 shows the relationship of the workpiece 16 and the rake surface 22 of the bit from the start of machining the intended formation region 23a of the axially symmetrical concave surface diffracting shapes to be machined, from the outer side, until the C axis has performed one revolution, the relationship being depicted at 90-degree intervals. In FIG. 4, reference numeral 23b is the machining start position. As shown in FIG. 4, while the C axis performs one revolution, the intended formation region 23a of the axially symmetrical concave surface diffracting shape also performs one revolution.

By means of the operation of one revolution described above, the outermost portion of the axially symmetrical concave surface diffracting shape 23 to be machined is formed. The machining apparatus then carries out a similar operation to the operation of the one revolution described above in a continuous fashion, in such a manner that, for example, the center of the intended formation region 23a of the axially symmetrical concave surface diffracting shape forms a spiral-shaped trajectory of travel from the outer side toward the inner side. Furthermore, the machining apparatus causes the front end of the bit 20 to cut in the Z-axis direction so as to follow the axially symmetrical concave surface diffracting shape 23. In this way, an axially symmetrical concave surface diffracting shape 23 is formed.

After forming the axially symmetrical concave surface diffracting shape to be machined, the machining apparatus aligns the front end of the bit with the machining start position on the intended formation region of the next adjoining axially symmetrical concave surface diffracting shape to be machined. The machining apparatus carries out the steps for forming the axially symmetrical concave surface diffracting shape described above, again.

By repeating the steps described above, a plurality of axially symmetrical concave surface diffracting shapes are formed in an array configuration in the workpiece. In this way, a master mold for forming a lens array in which the axially symmetrical concave surface diffracting shapes are arranged in an array configuration is prepared.

According to the present embodiment, the problems of the prior art: (1) that the arrangement of the machined shapes is limited; (2) that variations occur in the shape accuracy of the machined shapes; and (3) that variations also occur in the positional accuracy of the machined shapes are resolved.

In other words, (1) when forming a machined shape centered about an offset position distant from a rotational drive shaft (rotation center), a conventional machining apparatus causes a machining tool to turn so as to follow the offset position rotating about the rotation center. Therefore, a linear drive axis is required to have an operation range of at least twice the distance from the rotation center to the offset position. Consequently, a rotational curved surface is positioned only within a range from the rotation center to a half of the operation range of the linear drive axis.

On the other hand, in the present embodiment, the operation range of the linear drive axis when forming one machined shape is dependent on the diameter of the machined shape, but is independent of a position on the workpiece. Consequently, it is possible to obtain approximately twice the freedom of the prior art, in the arrangement of the rotational curved surface.

Furthermore, in the conventional machining apparatus, when forming a machined shape centered about the offset position distant from the rotational drive shaft (rotation center), the offset position and the machining tool are moved relatively while the machining tool is caused to turn so as to follow the offset position rotating about the rotation center. Therefore, the moving distance of the linear drive axis increases with the distance of the offset position from the rotation center, and accordingly the feed velocity of the linear drive axis also increases. Consequently, the arrangement of the machined shape is restricted by limits on the feed velocity of the linear drive axis. Furthermore, if the rotation speed of the rotational drive shaft is lowered and the linear drive axis is operated within the feed velocity limit of the linear drive axis, in order to avoid these restrictions, then the machining time increases. If the machining time becomes too long, then there is a risk of accuracy errors due to external factors, and a deterioration in the surface texture (surface property and state) of the workpiece due to wear of the tool. Due to these factors, in the conventional machining apparatus, the machined shape can be positioned effectively only within a range of several mm from the rotational drive shaft.

On the other hand, in the present embodiment, the operation range of the linear drive axis when forming a machined shape is dependent on the diameter of the machined shape, but is independent of a position on the workpiece. Consequently, the restrictions on the arrangement of the machined shape due to the limit of the feed velocity of the linear drive axis can be avoided.

(2) Moreover, in the conventional machining apparatus, when forming a machined shape, the machining tool is caused to turn so as to follow the offset position rotating about the rotation center. Consequently, the machining data and the feed velocity of the linear drive axis are different for each machined shape. Furthermore, as the distance from the rotation center to the offset position increases, then an error in the resolution pitch of the rotational drive shaft also increases. Due to these factors, in the conventional machining apparatus, variations occur in the shape accuracy of the machined shape.

On the other hand, in the present embodiment, the operation range of the linear drive axis when forming a machined shape is dependent on the diameter of the machined shape but is independent of a position on the workpiece, and therefore it is possible to form any machined shape at the same feed velocity using the same machining data. Therefore, variations in the shape accuracy of the machined shape are suppressed.

(3) Furthermore, in the conventional machining apparatus, as described above, the moving distance of the linear drive axis increases with the distance of the offset position from the rotation center, and accordingly the feed velocity of the linear drive axis also increases. Therefore, the linear drive axis is delayed in following, as the distance from the rotation center to the offset position increases. Consequently, the positional accuracy of the machined shape deteriorates. A positional error caused by this delay in following varies depending on the offset position. Therefore, in the conventional machining apparatus, variations occur in the positional accuracy of the machined shape. Moreover, as described above, the larger the distance of the offset position from the rotation center, the larger the error in the resolution pitch of the rotational drive shaft. Consequently, the error in this resolution pitch is a cause of variations in the positional accuracy of the machined shape.

On the other hand, in the present embodiment, the operation range of the linear drive axis when forming a machined shape is dependent on the diameter of the machined shape, but is independent of a position on the workpiece, and therefore the positional accuracy of the machined shape is governed by the accuracy of the initial position of the machining tool. In other words, the positional accuracy of the machined shape is governed by the static positioning accuracy of the linear drive axis. Therefore, it is possible to achieve an accuracy of a sub-micron level, in the positional accuracy of the machined shape.

According to the present embodiment, as described above, the positional restrictions on the machined shape are eased and it is possible to achieve machining with high shape accuracy and positional accuracy, regardless of the distance from the center of the workpiece.

Moreover, by using the two-axis moving table to position the front end of the machining tool on the axis line of the C axis, as in the present embodiment, it is possible to align the front end of the machining tool accurately on the axis line of the C axis. Consequently, it is possible to achieve machining with even higher accuracy.

In the present embodiment, a case is described in which the front end of the bit 20 is positioned on the axis line of the C axis by using the two-axis moving table 18, but the following modes are also possible.

Specifically, it is possible to measure the amount of positional deviation between the front end of the bit 20 and the axis line of the C axis in advance, and form a machined shape while correcting this positional deviation by means of the X-axis table 12 and the Y-axis table 13. The operation of the X-axis table 12 and the Y-axis table 13 is controlled on the basis of the previously measured amount of positional deviation. By adopting this composition, since the positional deviation is corrected by means of the X-axis table 12 and the Y-axis table 13, then it is not necessary to mount a heavy table on the side of the rotational drive shaft. Accordingly, it is possible to achieve a stable high-speed rotation of the rotational drive shaft. Consequently, it is possible to shorten the machining time and eliminate the causes of a deterioration in the shape accuracy due to the machining time. Therefore, it is possible to achieve machining with even higher shape accuracy and positional accuracy.

Furthermore, it is also possible, for instance, to perform rough positional alignment of the front end of the bit 20 and the axis line of the C axis by using the two-axis moving table 18, and then measure the amount of positional deviation between the front end of the bit 20 and the axis line of the C axis. By adopting this composition, it is possible to form a machined shape while correcting a slight positional deviation by means of the X-axis table 12 and the Y-axis table 13, and therefore it is possible to achieve both high operability for setting of the machining tool and high accuracy.

Possible methods of measuring the amount of positional deviation between the front end of the bit 20 and the axis line of the C axis may be, for example, a method in which the machining tool is rotated through 180 degrees and the deviations of the outlines of the side face and the upper face of the tool before and after rotation are observed under a high-power microscope, a method in which a shaping process is carried out two times respectively in the longitudinal direction and the lateral direction on a dummy piece by rotating the tool through 180 degrees, by cutting while moving the tool linearly without rotating the workpiece, and a deviation between the cut shapes is measured, or the like. Furthermore, it is also possible to actually form a machined shape and measure the amount of positional deviation between the front end of the bit and the axis line of the C axis from a deviation between the ideal machined shape and the actual machined shape.

Moreover, in the present embodiment, a case is described in which the orientation of the rake surface 22 of the bit is maintained at 180 degrees at all times with respect to the advance direction of the machined shape, but depending on the relationship between the workpiece and the machining tool, it is also possible to direct the orientation of the rake surface 22 of the bit in the negative direction or positive direction. For example, in order to improve the biting of the machining tool in the advance direction, it is possible to carry out machining with the orientation of the rake surface 22 of the bit directed at a predetermined angle in the negative direction with respect to the advance direction of the machined shape. Moreover, for example, in order to facilitate the discharge of swarf and improve surface roughness due to a burnishing effect, it is also possible to carry out machining with the orientation of the rake surface 22 of the bit directed at a predetermined angle in the positive direction with respect to the advance direction of the machined shape. By carrying out machining with the orientation of the rake surface 22 of the bit directed in the positive direction, it is possible to obtain favorable surface properties in the workpiece.

Furthermore, in the present embodiment, a case is described in which an axially symmetrical concave surface diffracting shape is formed, but when machining fine shapes of this kind such as diffraction gratings or cutting blade shapes, it is possible to use a machining tool having a large blade edge R which is beneficial for suppressing wear of the tool and shortening the machining time, and change the orientation of the rake surface of the bit with respect to the advance direction of the machined shape, thereby altering a portion of the machining tool to be in contact with the workpiece, during the formation of the machined shape to be machined.

Furthermore, in the present embodiment, a bit for performing a cutting operation is used as a machining tool, but it is also possible to use a grinding stone for performing a grinding operation. When using a grinding stone for machining by grinding, a grinding stone spindle is mounted on the tool mounting surface. Even in this case, machined shapes are formed with high accuracy in an array configuration on the workpiece, without variations in either positional accuracy or shape accuracy.

Moreover, the present embodiment was described with respect to a case of preparing a master mold for forming a lens array in which axially symmetrical concave surface diffracting shapes are arranged in an array configuration, but the present invention can also be applied to the preparation of an optical element having one machined shape or an array configuration of machined shapes such as an axially symmetrical shape, an axially asymmetrical shape or a free-form surface shape, or having a fine shape such as a diffraction grating or cutting blade shape, or the preparation of a mold or master mold for forming such an optical element.

The embodiment relating to the present invention was described in detail above, but a person skilled in the art could readily make various modifications to the exemplary embodiment described above, without substantially departing from the novel teachings and advantages of the present invention. Consequently, it is intended that various modifications of this kind are also included within the scope of the present invention.

What is claimed is:

1. A machining apparatus, comprising:
a rotational shaft;
a tool mounting surface on the rotational shaft;
a machining tool mounted on the tool mounting surface;
a workpiece mounting surface opposing the tool mounting surface; and
three linear axes for moving the tool mounting surface and the workpiece mounting surface relatively in three axial directions orthogonal to each other, wherein
the machining tool forms a machined shape in a workpiece mounted on the workpiece mounting surface, by means of the rotational shaft causing the machining tool to rotate, and the three linear axes moving the machining tool so as to follow a machined shape of a machining object while moving a center of an intended formation region of the machined shape of the machining object in a circular arc shape in accordance with the rotation of the machining tool.

2. The machining apparatus according to claim 1, wherein the rotational shaft and the three linear axes are operated such that a plurality of machined shapes are formed in the workpiece mounted on the workpiece mounting surface.

3. The machining apparatus according to claim 1, further comprising a two-axis table, disposed on the tool mounting surface, for holding the machining tool, wherein
the two-axis table positions a front end of the machining tool on an axis line of the rotational shaft.

4. The machining apparatus according to claim 1, wherein the three linear axes correct a positional deviation between a front end of the machining tool and an axis line of the rotational shaft during the formation of the machined shape.

5. The machining apparatus according to claim 4, further comprising a two-axis table, disposed on the tool mounting surface, for holding the machining tool, wherein
the two-axis table positions the front end of the machining tool in a vicinity of the axis line of the rotational shaft.

6. The machining apparatus according to claim 1, wherein the machining tool is a cutting tool or a grinding tool.

7. The machining apparatus according to claim 1, wherein
the machining tool is a cutting tool, and
the rotational shaft and the three linear axes maintain a constant angle of a rake surface of the machining tool with respect to an advance direction of the intended formation region of the machined shape of the machining object, during the formation of the machined shape of the machining object.

8. The machining apparatus according to claim 1, wherein
the machining tool is a cutting tool, and
the rotational shaft and the three linear axes alter an angle of a rake surface of the machining tool with respect to an advance direction of the intended formation region of the machined shape of the machining object, and change a portion of the machining tool to be in contact with the workpiece mounted on the workpiece mounting surface, during the formation of the machined shape of the machining object.

9. A machining method for forming a machined shape in a workpiece mounted on a workpiece mounting surface, by controlling an operation of a rotational shaft for rotating a tool mounting surface on which a machining tool is mounted and an operation of three linear axes for relatively moving the tool mounting surface and the workpiece mounting surface opposing the tool mounting surface, in three axial directions orthogonal to each other, wherein
after the machining tool is aligned in a machining start position on an intended formation region of a machined shape of a machining object, the machining tool is moved following the machined shape of the machining object, while a center of the intended formation region of the machined shape of the machining object is moved in a circular arc shape in accordance with the rotation of the machining tool.

10. The machining method according to claim 9, wherein a plurality of machined shapes are formed in the workpiece mounted on the workpiece mounting surface, by repeating the step of aligning the machining tool in the machining start position on the intended formation region of the machined shape of the machining object, and then moving the machining tool to follow the machined shape of the machining object, while moving the center of the intended formation region of the machined shape of the machining object in a circular arc shape in accordance with the rotation of the machining tool.

11. The machining method according to claim 9, wherein, before forming the machined shape, a front end of the machining tool is positioned on an axis line of the rotational shaft by controlling an operation of a two-axis table that is disposed on the tool mounting surface and that holds the machining tool.

12. The machining method according to claim 9, wherein the machined shape is formed in the workpiece mounted on the workpiece mounting surface while correcting a positional deviation between a front end of the machining tool and an axis line of the rotational shaft.

13. The machining method according to claim 12, wherein before forming the machined shape, the front end of the machining tool is positioned in a vicinity of the axis line of the rotational shaft by controlling an operation of a two-axis table that is disposed on the tool mounting surface and holds the machining tool.

14. The machining method according to claim 9, wherein a cutting tool or a grinding tool is used as the machining tool.

15. The machining method according to claim 9, wherein a cutting tool is used as the machining tool, and an angle of a rake surface of the machining tool is maintained constant with respect to an advance direction of the intended formation region of the machined shape of the machining object, during the formation of the machined shape of the machining object.

16. The machining apparatus according to claim 9, wherein a cutting tool is used as the machining tool, and an angle of a rake surface of the machining tool with respect to an advance direction of the intended formation region of the machined shape of the machining object is altered and a portion of the machining tool to be in contact with the workpiece mounted on the workpiece mounting surface is altered, during the formation of the machined shape of the machining object.
